(19) United States
(12) Patent Application Publication
(10) Pub. No.: US 2004/0220798 A1
(43) Pub. Date: Nov. 4, 2004

(54) Remote voice identification system

(75) Inventors: David M. Chi, Birmingham, MI (US); Mark R. Caron, Warren, MI (US); Ryan L. Templeton, Belleville, MI (US); Tim Stewart, Canton, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/427,353

(22) Filed: May 1, 2003

(51) Int. Cl. G10L 19/00

(52) U.S. Cl. 704/201

(57) ABSTRACT

A voice-based identification system allows a user to gain access to a vehicle. The user through the use of a user interface transmits a signal based on the user's voice to an identification module residing in the vehicle. A controller analyzes the signal with an algorithm implemented in the memory of the controller to determine if the user is an authorized user.

### BACKGROUND

1. Technical Field

The present invention relates generally to voice identification systems, and more particularly relates to voice identification systems for vehicle security systems.

2. Background Information

Current remote keyless entry systems for vehicles typically require the use of a handheld fob that transmits a radio frequency (“RF”) command signal to the vehicle. Unfortunately, these devices may be used by any individual possessing the device, such as a thief, to gain access to the vehicle. Several alternatives have been proposed to increase the security of keyless entry systems. One alternative uses biometric sensors on the exterior of the vehicle to ascertain the identity to assure that the individual is authorized user of the vehicle. Current biometric technologies, however, are not robust enough to operate under extreme environmental conditions.

Another alternative is to add the biometric sensor to the RF device itself. However, adding the biometric sensor and the associated processing power required to operate biometrics sensors on a RF device would dramatically increase the cost of the RF device and also substantially reduce battery life and increase the size of the device.

Another aspect of vehicular security involves the operation of the vehicle after the user enters the vehicle. Typical vehicle security systems require the use of keys or key codes to start the engine and/or to access secure compartments such as the trunk or glove compartment. Thus, any holder of the key gains immediate access to the entire vehicle, regardless if the holder is a thief or someone authorized to hold the key.

As for user convenience of the vehicle and comfort settings of individual users, most vehicles require the user to manually adjust the vehicle settings to their comfort level. However, these settings can be adjusted by other users so that the previous user must re-adjust the settings that individual's desired comfort settings. Certain vehicles have the ability to store the settings for each individual user in memory that can be recalled with, for example, a push button, but the push button is a manual process and is prone to user error when the wrong button is pressed or if the wrong settings are stored in memory. Moreover, users often do not remember whose settings are accessed with which buttons.

### BRIEF SUMMARY

The present invention provides a voice-based identification system that allows a user to gain access to a vehicle. With a user interface, the user transmits a signal based on the user's voice to an identification module residing in the vehicle. A controller analyzes the signal with an algorithm implemented in the memory of the controller. If a positive identification is made, the controller issues a command to the vehicle to perform one or more functions, such as unlocking one or more of the vehicle's doors or other secured compartments. Alternatively, the controller issues a command to implement the user's personal settings of the comfort features of the vehicle, such as settings for the seats, entertainment system, or heating/air conditioning system.

After the user enters the vehicle, the user may issue other vocalized expressions through a second user interface to obtain access to the vehicle's ignition and transmission and/or to implement the user's personal profile settings associated with certain comfort features of the vehicle.

The foregoing discussion has been provided only by way of introduction. Nothing in this section should be taken as a limitation on the following claims, which define the scope of the invention.

### BRIEF DESCRIPTION OF THE DRAWINGS

The accompanying drawings, incorporated in and forming a part of the specification, illustrate several aspects of the present invention and, together with the description, serve to explain the principles of the invention. The components in the figures are not necessarily to scale, emphasis instead being placed upon illustrating the principles of the invention. Moreover, in the figures, like reference numerals designate corresponding parts throughout the views. In the drawings:

FIG. 1 is a system diagram of a remote voice identification system in accordance with the invention;

FIG. 2 is a block diagram of a voice identification module of the system of FIG. 1 in accordance with the invention;

FIG. 3A is a flow diagram of a sequence of steps for the operation of the voice identification system of FIG. 1 in accordance with the invention; and

FIG. 3B is a flow diagram of a sequence of steps for the operation of the voice identification module of FIG. 2 in accordance with the invention.

### DETAILED DESCRIPTION

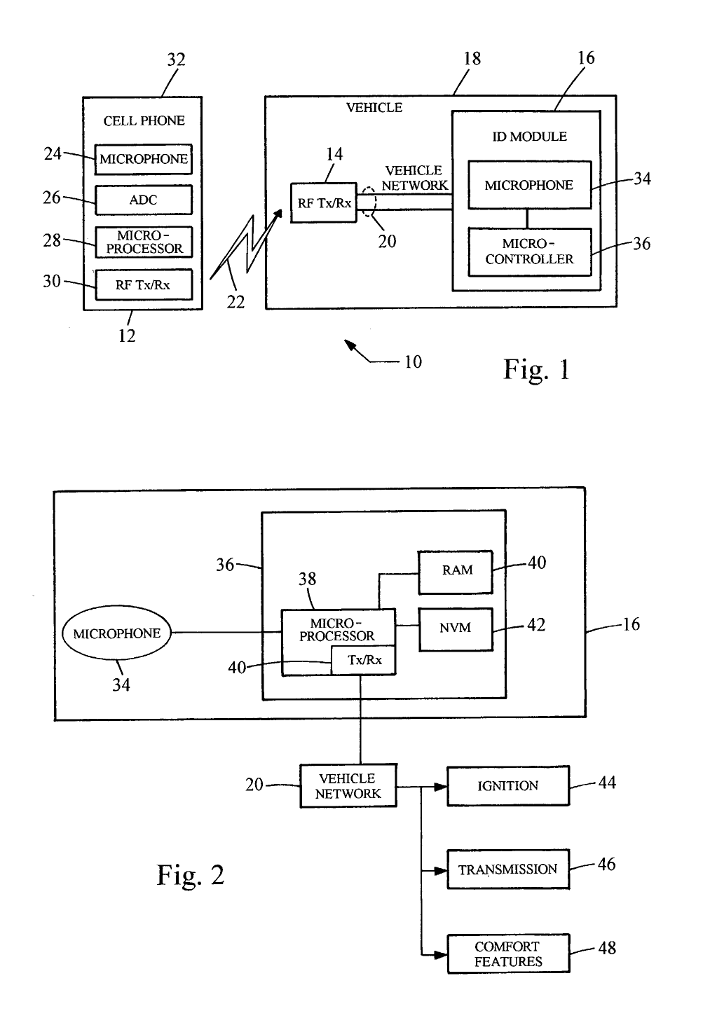

FIG. 1 illustrates a block diagram of a remote identification system, generally identified as 10, in accordance with the invention. The system 10 includes a user interface, such as a cell phone 12 or any other suitable device that is able to transmit radio frequency (“RF”) signals, a RF transceiver 14, and a voice ID module 16. The RF transceiver 14 and the voice ID module 16 reside inside a vehicle 18 and communicate with each other over a network 20.

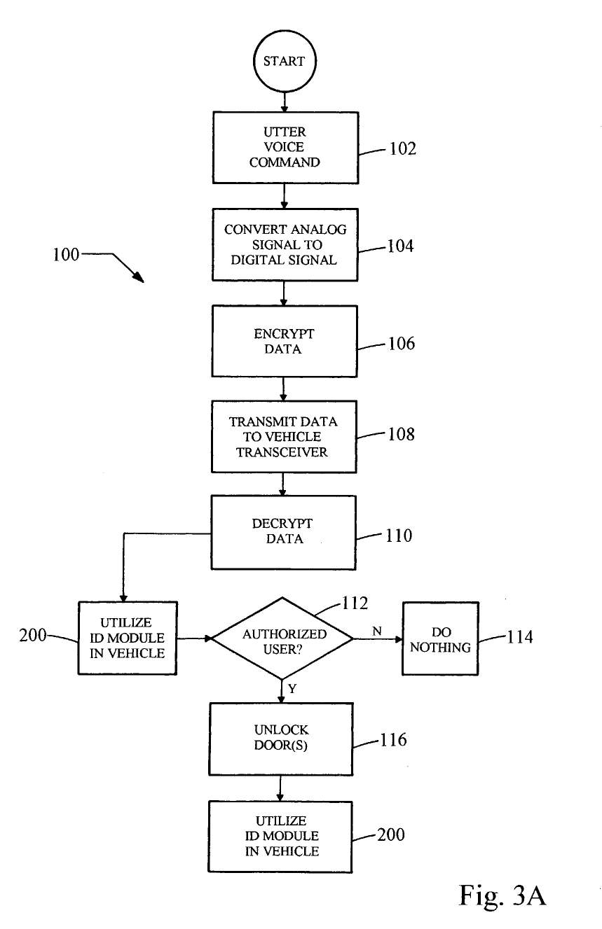

To use the system 10, a user typically utters a vocalized expression, such as a voice command, into the cell phone 12. For example, the user may say “open the door” or “unlock the door” and/or “open the trunk”, etc. This command is transmitted from the cell phone 12 to the transceiver 14 and to the voice ID module 16 from the transceiver 14 via the network 20. If the voice ID module 16 determines that the user is an authorized user, the system 10 implements the voice command, for example, it unlocks the doors. In some configurations, the user may be required to utter a password or passphrase or a pin number in addition to the voice command. Alternatively, uttering the correct password, passphrase or pin number may be sufficient to gain access to the interior of the vehicle. Moreover, the voice commands may be associated with personal settings of the comfort features 48 (FIG. 2) of the vehicle. For example, the user may utter commands into the cell phone 12 to set the seats, entertainment system, or heating/air conditioning system.

In most circumstances, the cell phone 12 is located in close proximity to a user, but because the cell phone 12 communicates with the RF transceiver 14 through RF signals 22, the cell phone 12 may be used wherever it can communicate with the transceiver 14 through a cellular network. That is, the cell phone 12 and the vehicle 18 can be located some distance apart, for example, tens, hundreds, or thousands of miles apart, if the cell phone 12 and the transceiver 14 are able to communicate with each other through the cellular network. Alternatively, the system 10 can be used in other wireless communication systems, such as Bluetooth™.

As seen in FIG. 1, the cell phone 12 is provided with a microphone 24, an analog to digital converter (“ADC”) 26, a microprocessor 28, and a remote RF transceiver 30, which are all mounted within a shell 32. Referring to FIG. 2, the ID module 16 includes a microphone 34 and a microcontroller 36 provided with a microprocessor 38, RAM 40, and non-volatile memory (“NVM”) 42. Operating instructions, which may be for a wide variety of functions including by not limited to, the vehicle's ignition 44, transmission 46, comfort features 48, and door locks 49, are transmitted from a transceiver 40 associated with the microprocessor 38 through the network 20.

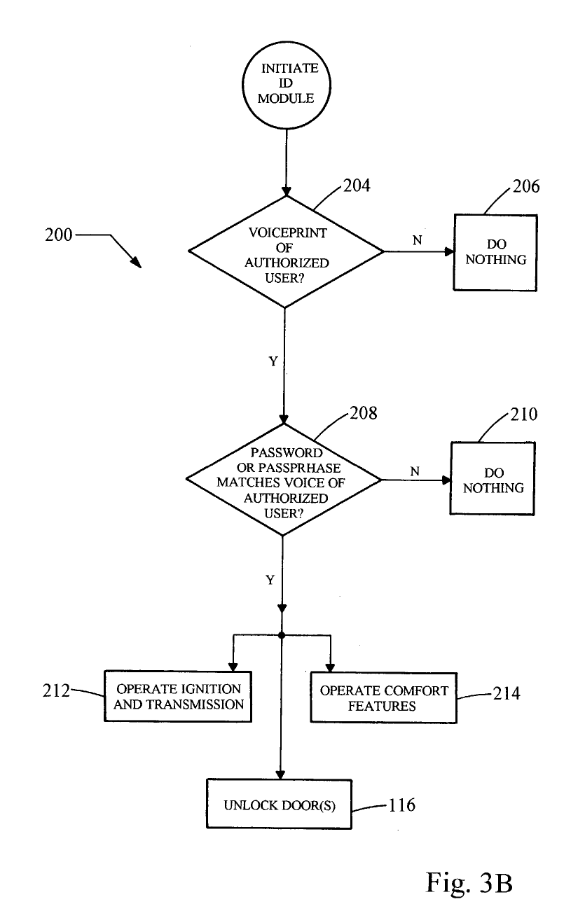

Referring now to FIG. 3A, there is shown a process 100 that depicts the generally operation of the system 10. In step 102, the user utters a voice command and/or a password or passphrase and the microphone 24 coverts the vocalized expression to an analog signal. In step 104, the ADC 26 converts the analog signal to a digital signal, and in step 106, the microprocessor 28 encrypts the digital data for added security, if desired. Subsequently, the microprocessor 28 communicates the encrypted data to the RF transceiver 30, which in step 108 transmits the data to the RF transceiver 14 residing in the vehicle 18.

Next, the transceiver 14 sends the data to the ID module 16 through the network 20. Here, in step 110, the microcontroller 36 decrypts the data, and subsequently, the process 100 utilizes a subprocess 200, shown in greater detail in FIG. 3B, to determine if the user is an authorized user. In particular, the microprocessor 38 in conjunction with RAM 40 uses a voice identification algorithm implemented in the NVM 42, which may provide user profile information, such as the user's voiceprint, password passphrase information, and comfort settings, to analyze the vocalized expression.

In the system 10, the ID module 16 utilizes multiple voice identification technologies. The first component (step 204) is a voiceprint characterization algorithm that looks for specific characteristics in the user's voice print, such as the harmonic frequencies of the voice. The basis for the algorithm can be provided, for example, by a SpeechSecure application from SpeechWorks, Inc., of Boston, Mass. Accordingly, if the voiceprint matches that stored in the NVM 42, the subprocess 200 proceeds to the next component (step 206) of the voice identification process. Otherwise, the process 100 terminates and does nothing, as indicated by step 206.

The second component of the ID module 16 (step 208) is a password or passphrase and voice recognition engine that checks for specific information supplied by the user. That is, the voice recognition engine assures that the uttered password or phrase matches with the password of phrase assigned to a particular voice. For example, the password or phrase may be the user's birthdate. Thus, when the user says the birth date, the voiceprint engine (step 204) first verifies that the voice has the correct characteristics, and subsequently the password and voice recognition engine (step 208) verifies that the spoken birth date (the passphrase) is the same as the birth date (the passphrase) associated with the user's voice.

If a positive identification is made in step 208, the microprocessor 38 issues a command in step 116, for example, to unlock one or more doors, and/or other secured compartments of the vehicle, or to set the comfort features to the personal settings of the user.

After the user enters the vehicle, the vehicle based microphone 34 can be utilized to identify the user for higher security privileges, such as the operation of the ignition 44, the transmission 46, or comfort features 48 associated with the user's personal profile settings stored in the controller's NVM 42.

Once inside the vehicle, the user again utters a voice command and/or a password or passphrase, and the microphone 34 converts the command into electrical energy that is digitized and processed by the microprocessor 38 in conjunction with RAM 40 and with the voice identification algorithm stored in the onboard NVM 42.

Again, the ID module 16 utilizes the subprocess 200 shown in FIG. 3B. As mentioned previously, in step 204, the subprocess 200 checks the user's voiceprint. If the user fails this component, the subprocess 200 in step 206 does nothing, otherwise the subprocess 200 proceeds to step 208, which is the second component of the voice identification algorithm, namely, the password or passphrase and voice recognition engine of the algorithm.

As mentioned earlier, failure of the voice recognition component results in the process doing nothing, that is, access to the vehicle's ignition, transmission, and comfort features is denied. If the user passes this component, then the user is allowed to operate the ignition, transmission, and comfort features, as indicated by steps 212 and 214.

Additionally, the ID module 16 assigns each access attempt with a confidence factor. If the confidence factor is high, the system 10 grants immediate access. If the confidence factor is below a given threshold, the system 10 may require additional security checks such as second password or passphrase.

After the ID module 16 identifies the user as an authorized user, the system 10 allows the user to start the vehicle 19. Additionally, the user gains access to his or her personal profile settings which are recalled from memory. For example, the settings can be comfort settings, such as radio presets, seat position, mirror settings, climate control, etc.

It is therefore intended that the foregoing detailed description be regarded as illustrative rather than limiting, and that it be understood that it is the following claims, including all equivalents, that are intended to define the spirit and scope of this invention. For example, in some implementations of the system 10, the system employs only one voice identification engine (steps 204 or 208) when the user utters a vocalized expression to unlock the doors. Similarly, after the user enters the vehicle, only one engine may be used to determine if the user is allowed to operate the ignition, transmission, or comfort features of the vehicle. Whether the system 10 employs one or both voice identification engines at each stage of the process depends on the desired level of security. Furthermore, as mentioned earlier, the user may issue commands from outside the vehicle to set the comfort features to desired personal settings, rather than waiting to enter the vehicle to issue such commands.

In some implementations, the RF transmitting device, such as the cell phone 12, transmits numeric commands to a transceiver in the vehicle, where a controller translates the numeric commands into the vehicle commands discussed above.

What is claimed is:

1. A remote voice identification system for vehicles, comprising
a first user interface that receives a first vocalized expression from a user;
a first transceiver and a second transceiver, the first transceiver transmitting a radio frequency (“RF”) signal associated with the first vocalized expression to the second transceiver that is located within the vehicle;
a controller located within the vehicle, the controller communicating with the second transceiver and analyzing the RF signal with a voice identification algorithm implemented in the memory of the of the controller to determine if the user is authorized an authorized user; and
a second user interface located within the vehicle, the second user interface receiving a second vocalized expression from the user when the user is inside the vehicle.

2. The system of claim 1, further comprising an analog to digital converter, the first user interface converting the first vocalized expression into an analog signal and the analog to digital converter converting the analog signal to a digital signal, the digital signal being the RF signal transmitted by the first transceiver.

3. The system of claim 2, further comprising a remote microprocessor which encrypts the digital signal, the controller being provided with a second microprocessor for decrypting the digital signal.

4. The system of claim 1, wherein the first vocalized expression is a voice command.

5. The system of claim 1, wherein the first vocalized expression is a password or passphrase.

6. The system of claim 1, wherein the user utters the second vocalized expression to gain access to the vehicle's ignition.

7. The system of claim 1, wherein the user utters the second vocalized expression to implement personal profile settings.

8. The system of claim 1, wherein the memory is implemented with a voice identification algorithm used by an onboard microprocessor of the controller to analyze the first and second vocalized expressions using user profile information stored in the memory.

9. The system of claim 8, wherein the voice identification algorithm includes a voiceprint characterization engine that analyzes specific characteristics of the user's voice.

10. The system of claim 9, wherein the specific characteristics is the harmonic frequencies of the user's voice.

11. The system of claim 8, wherein the voice identification algorithm includes a voice recognition engine that checks for specific information contained in the vocalized expression to assure that the vocalized expression matches with a particular individual.

12. A method of voice identification for vehicles, comprising
receiving a first vocalized expression from a user through a first user interface;
transmitting a radio frequency (“RF”) signal associated with the first vocalized expression from a first transceiver to a second transceiver that is located within the vehicle;
communicating the RF signal from the second transceiver to a controller;
analyzing the RF signal with a voice identification algorithm implemented in the memory of the of the controller to determine if the user is authorized an authorized user; and
receiving a second vocalized expression from the user when the user is inside the vehicle through a second user interface.

13. The method of claim 12, further comprising converting the first vocalized expression into an analog signal with the first user interface, and converting the analog signal to a digital signal with an analog to digital converter, the digital signal being the RF signal transmitted by the first transceiver.

14. The method of claim 13, further comprising encrypting the digital signal with a microprocessor, the controller being provided with a second microprocessor for decrypting the digital signal.
